(19) United States
(12) Patent Application Publication
(10) Pub. No.: US 2020/0248738 A1
(43) Pub. Date: Aug. 6, 2020

(54) SUCTION CUP

(71) Applicant: TEN SHENG ASSORTED HOUSEWARE CO., LTD., Taichung City (TW)

(72) Inventors: TSUNG-CHIH CHANG, Taichung City (TW); YUAN-PO CHANG, Taichung City (TW)

(21) Appl. No.: 16/267,589

(22) Filed: Feb. 5, 2019

(51) Int. Cl. F16B 47/00

(52) U.S. Cl. CPC F16B 47/00; F16M 13/02

(57) ABSTRACT

A suction cup is provided, including: a suction member, including a seat body, a control member movably disposed on the seat body and a cup portion disposed on the seat body, the suction member further including a first air chamber, a second air chamber, a flow channel, an outlet channel and an inlet channel, the flow channel communicating with the first and second air chambers, the outlet channel communicating with the first air chamber, the control member including an air-tight ring portion, the air-tight ring portion openably closing and blocking the outlet channel, the inlet channel communicating with the second air chamber and the atmosphere; a check valve, disposed within the flow channel, openably closing the flow channel and allowing air to flow from the second air chamber to the first air chamber; a pressure relief valve portion, openably sealing and blocking the inlet channel.

### BACKGROUND OF THE INVENTION

### Field of the Invention

The present invention relates to a suction cup.

### Description of the Prior Art

In prior arts, a suction cup device includes a suction member, a check valve which disposed in the suction member, an exterior cover unit which is connected to the suction member and a manual exhaust valve which is disposed in the exterior cover unit, the suction member includes a cup portion, a protrusive seat and an air storage chamber which extends from the cup portion toward the protrusive seat, the check valve is disposed within a valve hole of the protrusive seat and allows air to be released from the air storage chamber toward the protrusive seat, the exterior cover unit includes an air storage space which has a flexible capacity and communicates with the air storage chamber through the check valve and an outlet channel which communicates with the atmosphere through the air storage space, and the manual exhaust valve can change a state of the outlet channel from close to open.

When the suction cup device of the prior art is in a vacuum state to make the suction member to suck on an attachment, a user has to pull open the suction member relative to the attachment to produce a gap therebetween so that air can enter the air storage space to release pressure. However, if the suction member sucks on the attachment too tightly, it is difficult and time-consuming to pull open the suction member. In addition, after being pulled open for a long term of time, an edge of the suction member may be deformed and damaged, and a suction effect may decrease.

The present invention has arisen to mitigate and/or obviate the afore-described disadvantages.

### SUMMARY OF THE INVENTION

The major object of the present invention is to provide a suction cup which is easy for a user to operate to release pressure quickly.

To achieve the above and other objects, a suction cup is provided, including: a suction member, including a seat body, a control member which is movably disposed on the seat body and a cup portion which is elastically deformable, the cup portion being disposed on the seat body and configured to contact a surface, the suction member further including a first air chamber, a second air chamber, a flow channel, an outlet channel and an inlet channel, the flow channel communicating with the first and second air chambers, the outlet channel communicating with the first air chamber and the atmosphere, the control member including an air-tight ring portion, the air-tight ring portion openably closing the outlet channel and blocking the outlet channel, the inlet channel communicating with the second air chamber and the atmosphere; a check valve, disposed within the flow channel, openably closing the flow channel and allowing air to flow from the second air chamber to the first air chamber; a pressure relief valve portion, openably sealing the inlet channel and blocking the inlet channel.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a stereogram of the first preferred embodiment of the present invention in use;

FIG. 3 is a breakdown view of the first preferred embodiment of the present invention;

FIG. 4 is another breakdown view of the first preferred embodiment of the present invention;

FIGS. 5 to 7 are cross-sectional views of the first preferred embodiment of the present invention in operation;

FIG. 8 is a stereogram of a second preferred embodiment of the present invention;

FIG. 9 is a partially-enlarged view of FIG. 8;

FIG. 10 is a breakdown view of a third preferred embodiment of the present invention;

FIG. 11 is a stereogram of the third preferred embodiment of the present invention;

FIG. 12 is a stereogram of a cup portion of the third preferred embodiment of the present invention;

FIG. 13 is a cross-sectional view of a control member being non-pressed of the third preferred embodiment of the present invention;

FIG. 14 is a cross-sectional view of a control member being pressed of the third preferred embodiment of the present invention;

FIG. 15 is a cross-sectional view of a check valve being open of the third preferred embodiment of the present invention;

FIG. 16 is a stereogram of a fourth preferred embodiment of the present invention; and

FIG. 17 is a stereogram of a cup portion of the fourth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

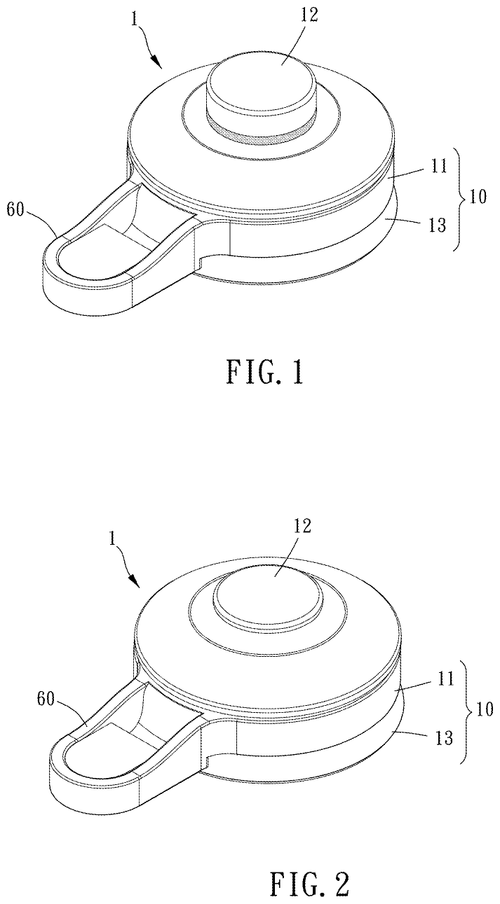

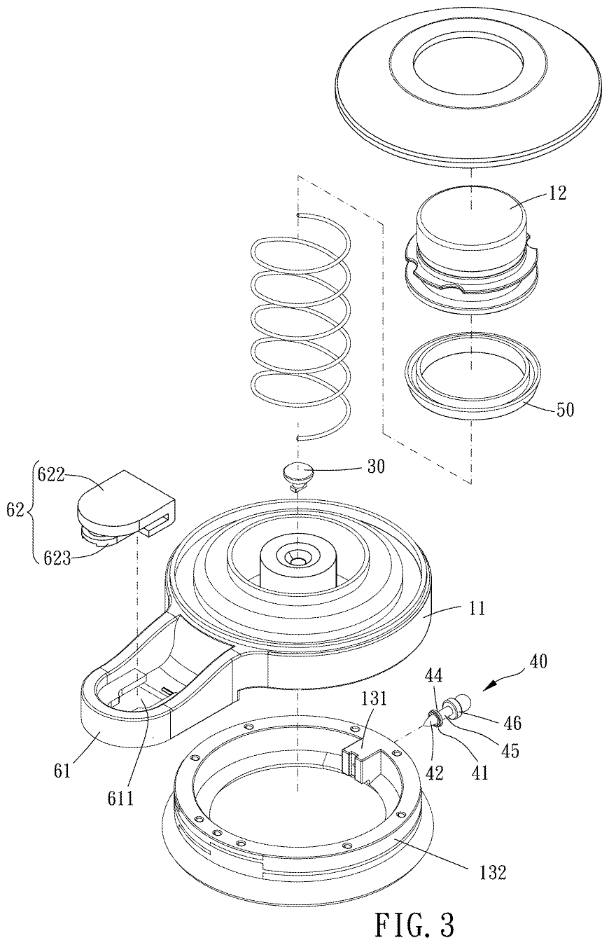

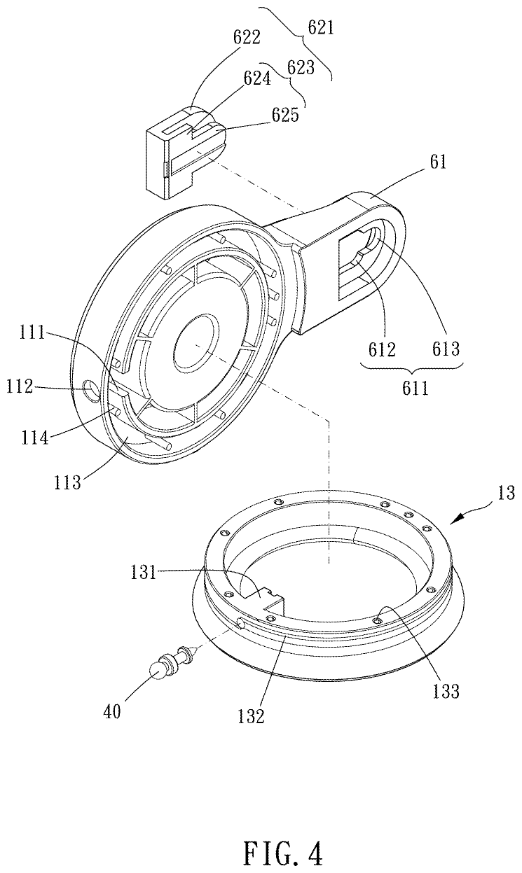

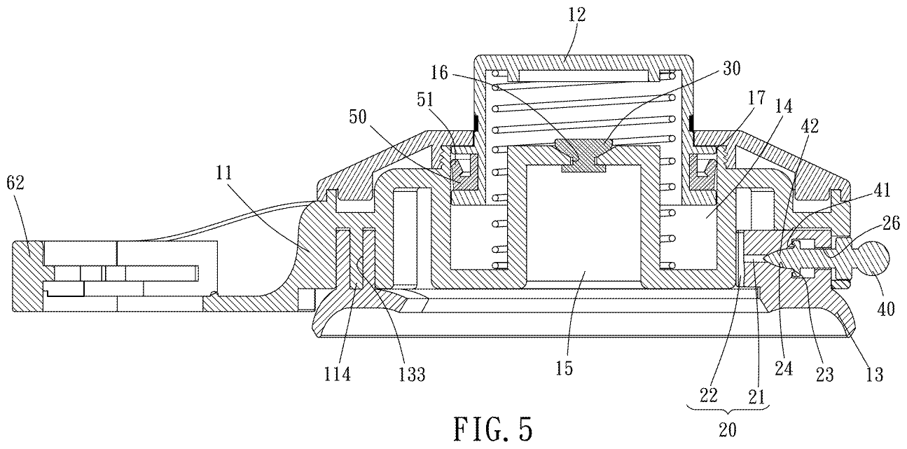

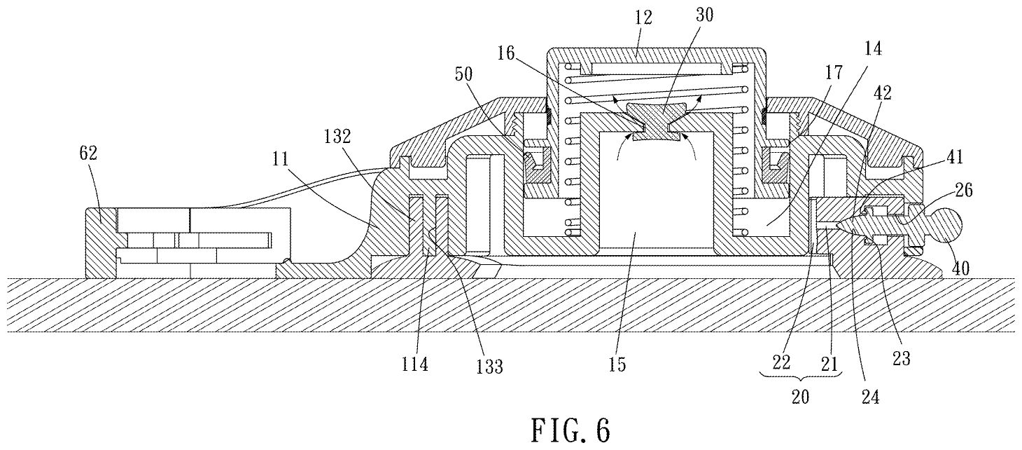

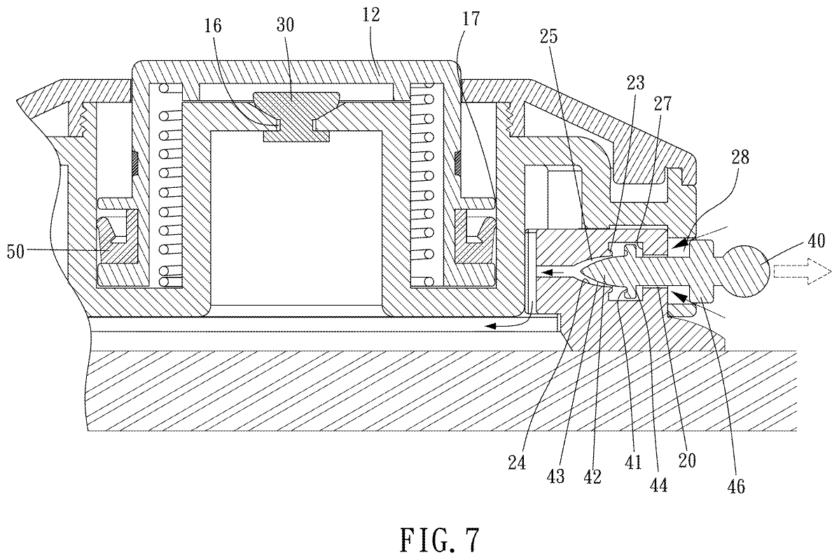

Please refer to FIGS. 1 to 7 for a preferred embodiment of the present invention. A suction cup 1 includes a suction member 10, a check valve 30 and a pressure relief valve portion.

The suction member 10 includes a seat body 11, a control member 12 which is movably disposed on the seat body 11 and a cup portion 13 which is elastically deformable, the cup portion 13 is disposed on the seat body 11 and configured to contact a surface, the suction member 10 further includes a first air chamber 14, a second air chamber 15, a flow channel 16, an outlet channel 17 and an inlet channel 20, the flow channel 16 communicates with the first and second air chambers 14, 15, the outlet channel 17 communicates with the first air chamber 14 and the atmosphere, the control member 12 includes an air-tight ring portion 50, the air-tight ring portion 50 openably closes the outlet channel 17 and blocks the outlet channel 17, and in this embodiment, the air-tight ring portion 50 may also be a rubber ring body or other elastic bodies; the air-tight ring portion 50 projects into the outlet channel 17 and openably and annularly abuts against an inner circumferential wall of the outlet channel 17; the inlet channel 20 communicates with the second air chamber 15 and t the atmosphere, and the inlet channel 20 penetrates one of the seat body 11 and the cup portion 13; the check valve 30 is disposed within the flow channel 16, and the check valve 30 openably closes the flow channel 16 and allows air to flow from the second air chamber 15 to the first air chamber 14; in this embodiment, the check valve 30 is movably disposed within the flow channel 16, and the check valve 30 can receive a force to deform so as to open and close the flow channel 16; the pressure relief valve portion openably seals the inlet channel 20 and blocks the inlet channel 20 so as to release pressure quickly.

In this embodiment, the seat body 11 and the cup portion 13 define the second air chamber 15 to simply structure and increase a suction effect and service life. In other embodiments, the second air chamber may be defined by the cup portion.

One of the seat body 11 and cup portion 13 has a recess, the other of the seat body 11 and cup portion 13 has a protrusion which is inserted into the recess, the cup portion 13 is detachably assembled to the seat body 11, in this embodiment, the seat body 11 has the recess 111, the cup portion 13 has the protrusion 131, when the protrusion 131 is assembled to the recess 111, and two opposite sides of the protrusion 131 abut against two opposite sides of the recess 111 of the seat body 11 to achieve a preferable positioning effect. In this embodiment, the cup portion 13 is made of elastic rubber, and the inlet channel 20 penetrates the protrusion 131 so that the cup portion 13 is easy to be manufactured and can be stably assembled to the seat body 11. In this embodiment, the inlet channel 20 includes a first flow channel 21 and a second flow channel 22 which is lateral to the first flow channel 21, and the first and second flow channels 21, 22 are disposed through the protrusion 131, so air can flows to the second air chamber 15 from multiple directions to increase a pressure relief speed.

In this embodiment, the pressure relief valve portion is a pressure relief valve body 40 which disengageably abuts annularly against an inner wall of the inlet channel 20 and blocks the inlet channel 20. Specifically, the inlet channel 20 is disposed in the cup portion 13, and the pressure relief valve body 40 and the cup portion 13 are not integrally formed.

One of the pressure relief valve body 40 and a circumferential wall of the inlet channel 20 has a ring concave, and the other of the pressure relief valve body 40 and the circumferential wall of the inlet channel 20 has a ring protrusion which tightly abuts against the ring concave. In this embodiment, the pressure relief valve body 40 has the ring concave 41, the circumferential wall of the inlet channel 20 has the ring protrusion 23, and the ring concave 41 and the ring protrusion 23 respectively extend toward a direction of the pressure relief valve body 40 moving opposite to the inlet channel 20 to enhance the air-tight effect.

The pressure relief valve body 40 has a cone section 42, and the cone section 42 is insertable within the inlet channel 20 to annularly abut against the inlet channel 20 and block the inlet channel 20 to enhance the air-tight effect. In this embodiment, the inlet channel 20 has a tapered section 24, and the cone section 42 is insertable within the tapered section 24 to annularly abut against the tapered section 24 and block the inlet channel 20 so as to increase a abutting area between the cone section 42 and the tapered section 24 to provide a preferable air-tight effect. The tapered section 24 is smaller than the cone section 42 in extension length to enhance an abutting effect and further to provide a preferable air-tight effect. In this embodiment, the cone section 42 has a curved protrusive circumference 43, and the tapered section 24 has a curved recessed circumference 25 which is complementary to the curved protrusive circumference 43 to enhance the air-tight effect. In other embodiments, the circumferences of the cone section and the tapered section may be planes which are complementary with each other.

The inlet channel 20 has a neck section 26, the neck section 26 has a first ring protrusive face 27 which extends radially and inwardly, the pressure relief valve body 40 has a second ring protrusive face 44 which extends radially, the second ring protrusive face 44 and the first ring protrusive face 27 abut against each other, and the second ring protrusive face 44 is located between the first ring protrusive face 27 and the second air chamber 15 to achieve the positioning effect.

The seat body 11 has a through hole 112, the through hole 112 communicates with the inlet channel 20, the pressure relief valve body 40 has a body section 45 which is disposed within the through hole 112 and inlet channel 20, the body section 45 has an annular flange 46, a radial dimension of the annular flange 46 is smaller than a caliber of the through hole 112 and greater than a caliber of an entrance 28 of the inlet channel 20, and the annular flange 46 can close the entrance 28 to provide the air-tight effect and can be received within the through hole 112 to achieve the positioning effect and stably move relative to the inlet channel 20.

One of the seat body 11 and the cup portion 13 has an annular groove, the other of the seat body 11 and the cup portion 13 has an engaging protrusion which is engaged within the annular groove, one of the annular groove and the engaging protrusion has at least one slot, and the other of the annular groove and the engaging protrusion has a column which is disposed within the slot. In this embodiment, the seat body 11 has the annular groove 113, and the cup portion 13 has the engaging protrusion 132 so that the cup portion 13 can be directly assembled to or disassembled from the annular groove 113. In this embodiment, the annular groove 113 has each said column 114, and the engaging protrusion 132 has each said slot 133; in addition, the at least one slot 133 is plural, and the at least one column 114 is plural so as to prevent the cup portion 13 from being deformed and laterally detached due to overweight.

In addition, the air-tight ring portion 50 has a circumferential abutting sheet 51, the circumferential abutting sheet 51 radially movably and detachably abuts against an inner circumferential wall of the outlet channel 17 and blocks the outlet channel 17, so the circumferential abutting sheet 51 can be detached from the inner circumferential wall of the outlet channel 17 to allow air pass therethrough.

In addition, the suction cup 1 further includes a hanging structure 60, the hanging structure 60 includes a base portion 61 which is connected to the seat body 11 and a hanging portion 62, one of the base portion 61 and the hanging portion 62 has a penetrating hole, and the other of the base portion 61 and the hanging portion 62 has a buckle member. In this embodiment, the base portion 61 has the penetrating hole 611, the hanging portion 62 has the buckle member 621, the buckle member 621 has a first clip sheet 622 and a second clip sheet 623 which is spacingly connected to the first clip sheet 622, the penetrating hole 621 has a radially-broadened hole 612 and a radially-narrowed hole 613 which communicates with the radially-broadened hole 612, the second clip sheet 623 has a wide section 624 and a narrow section 625 which is connected to the wide section 624, the wide section 624 corresponds to the radially-broadened hole 612, the narrow section 625 corresponds to the radially-narrowed hole 613, and the narrow section 625 is longer than the wide section 624 in a direction in which the wide section 624 and the narrow section 625 are arranged so as to be quickly assembled and disassembled. In practice, the buckle member 621 is disposed within the penetrating hole 611 and moves relative to the penetrating hole 611 so that the first and second clip sheets 622, 623 can clip a hole edge of the penetrating hole 611.

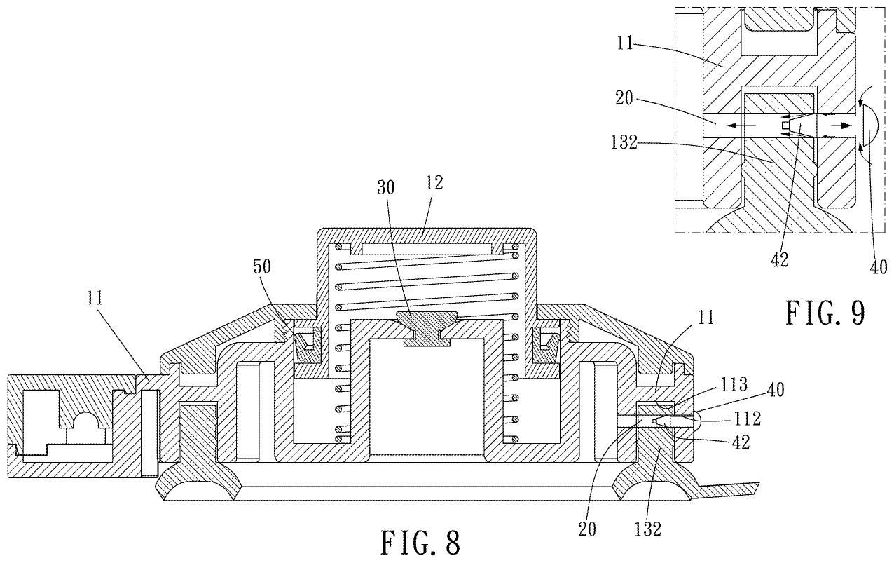

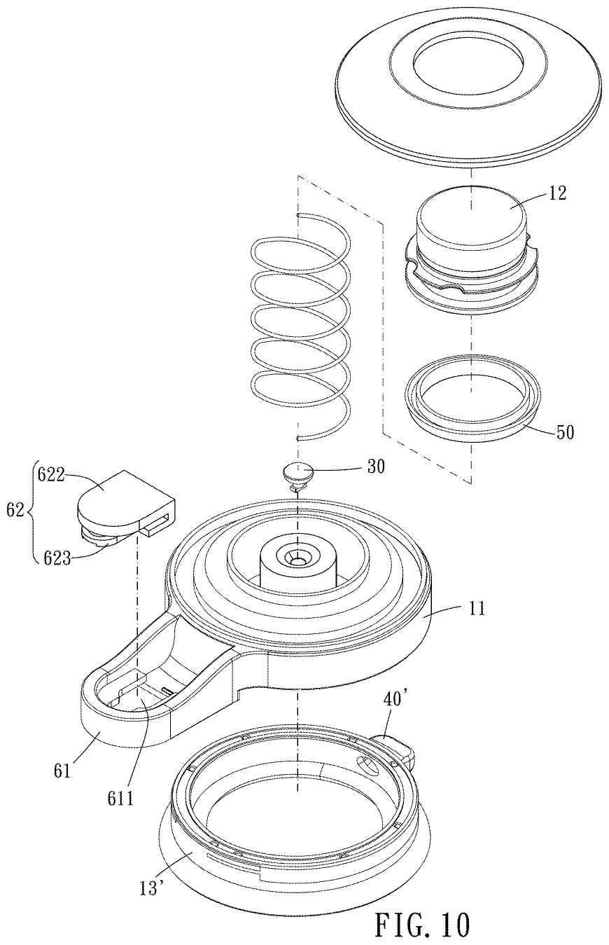

Please refer to FIGS. 8 and 9 for a second preferred embodiment. The difference between the first and second preferred embodiments is that in the second preferred embodiment, the inlet channel 20 penetrates a groove wall of the annular groove 113 and the engaging protrusion 132.

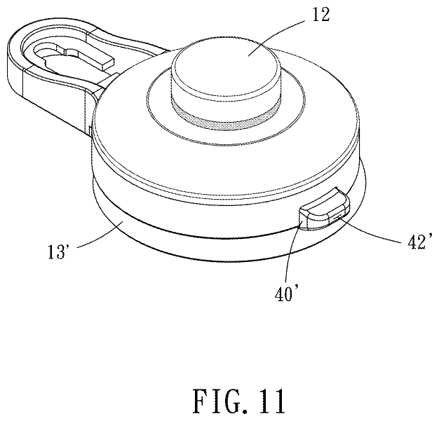

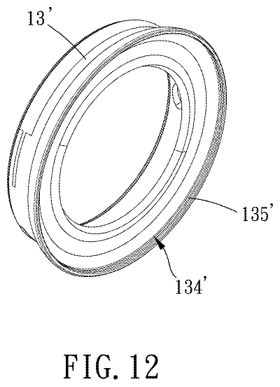

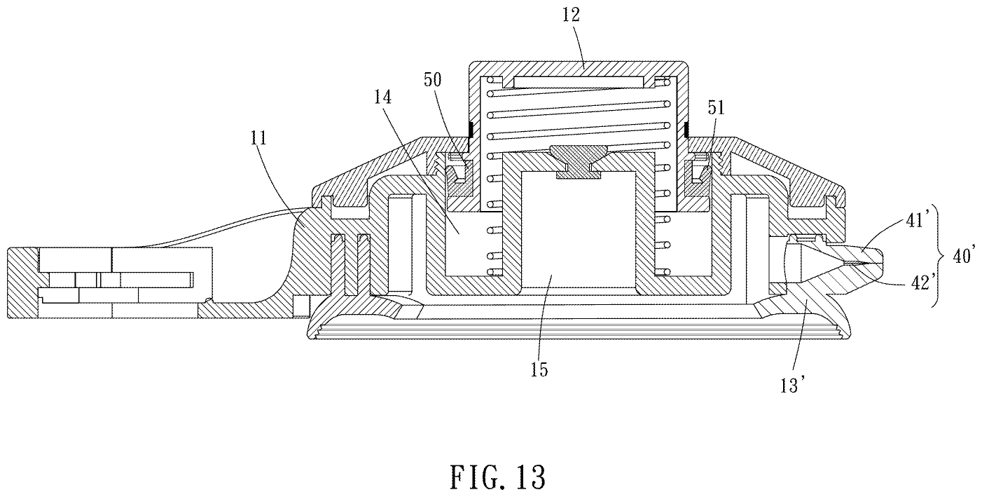

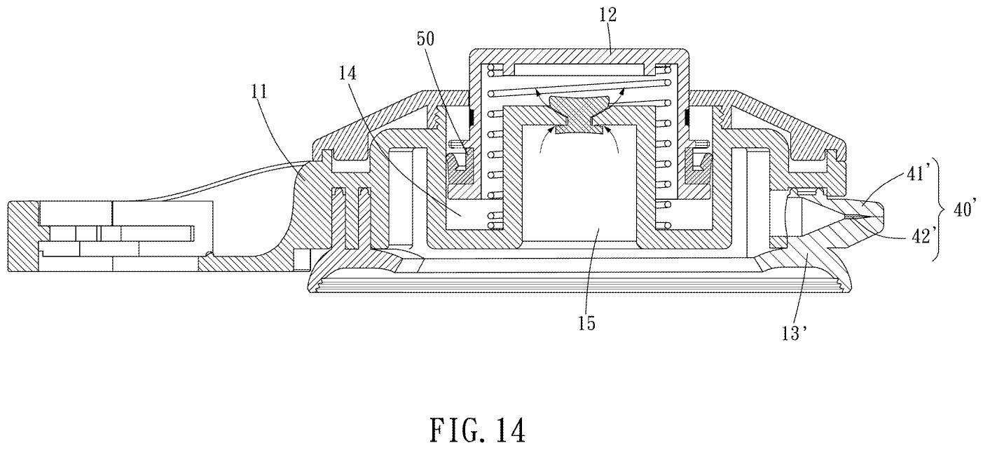

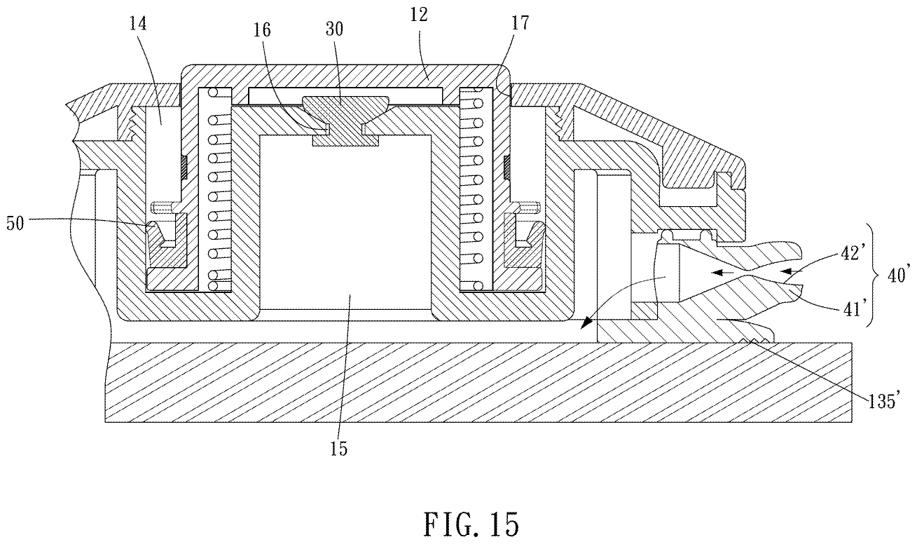

Please refer to FIGS. 10 to 15 for a third preferred embodiment. The difference between the first and third preferred embodiments is that in the third preferred embodiment, the pressure relief valve portion is a pressure relief check valve 40′ which is elastically deformable and integrally formed as a part of the cup portion 13′, the pressure relief check valve 40′ has a wall 41′ which is elastically deformable and an inlet gap 42′ which is defined by the wall 41′, and the inlet gap 42′ communicates with the inlet channel 20. Therefore, the wall 41′ can deform through pressing; normally, air can go out through the second air chamber 15 and cannot enter from the second air chamber 15, and as the pressure increases, the inlet gap 42′ closes more tightly.

Furthermore, the cup portion 13′ has a bottom face 134′ for contacting the surface, the bottom face 134′ has a plurality of annular protrusive ribs 135′, and specifically, the plurality of annular protrusive ribs 135′ are made of a deformable material to increase the air-tight effect.

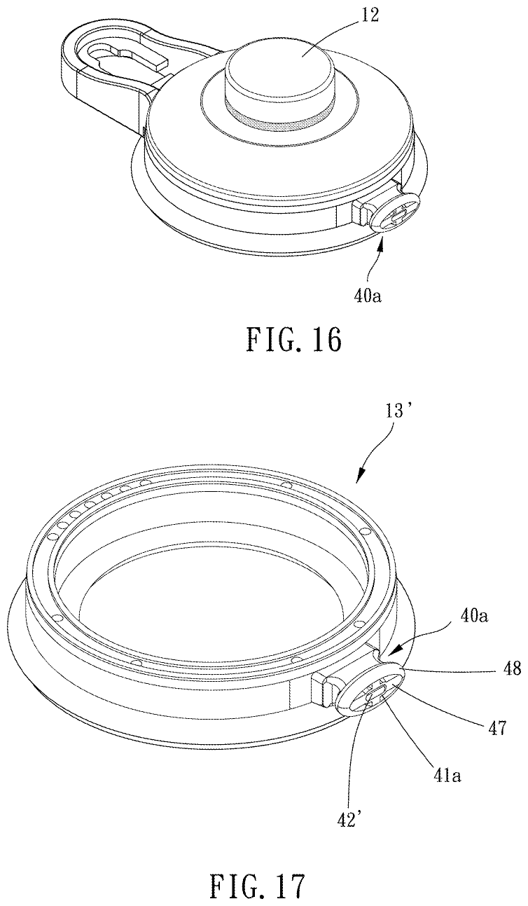

Please refer to FIGS. 16 and 17 for a fourth preferred embodiment. The difference between the third and fourth preferred embodiments is that in the fourth preferred embodiment, the pressure relief check valve 40′ further has an oval ring 48 and a plurality of ribs 47 which extend radially, each of the plurality of ribs 47 is connected to and between the wall 41a and the oval ring 48, in other embodiments, the oval ring may be round, square or polygonal, and through pressing two opposite sides of the oval ring, the wall 41a can be prevented from being overly deformed so that the wall can deform to open the inlet gap 42′.

In practice, when moving the control member 12 relative to the seat body 11, the air in the first and second air chambers 14, 15 can be exhausted to form an air-tight state, and the cup portion 13 flexibly deforms to tightly fit to the base face and suck thereon; and the user can further control the pressure relief valve portion to open or close the inlet channel 20.

Given the above, through controlling the pressure relief valve body to move relative to the inlet channel, the pressure can be quickly released.

While we have shown and described various embodiments in accordance with the present invention, it should be clear to those skilled in the art that further embodiments may be made without departing from the scope of the present invention.

What is claimed is:

1. A suction cup, including:
a suction member, including a seat body, a control member which is movably disposed on the seat body and a cup portion which is elastically deformable, the cup portion being disposed on the seat body and configured to contact a surface, the suction member further including a first air chamber, a second air chamber, a flow channel, an outlet channel and an inlet channel, the flow channel communicating with the first and second air chambers, the outlet channel communicating with the first air chamber and the atmosphere, the control member including an air-tight ring portion, the air-tight ring portion openably closing the outlet channel and blocking the outlet channel, the inlet channel communicating with the second air chamber and the atmosphere;
a check valve, disposed within the flow channel, openably closing the flow channel and allowing air to flow from the second air chamber to the first air chamber;
a pressure relief valve portion, openably sealing the inlet channel and blocking the inlet channel.

2. The suction cup of claim 1, wherein the seat body and the cup portion define the second air chamber.

3. The suction cup of claim 1, wherein the pressure relief valve portion is a pressure relief check valve which is elastically deformable and integrally formed as a part of the cup portion, the pressure relief check valve has a wall which is elastically deformable and an inlet gap which is defined by the wall, and the inlet gap communicates with the inlet channel.

4. The suction cup of claim 1, wherein pressure relief valve portion is a pressure relief valve body which disengageably abuts annularly against an inner wall of the inlet channel and blocks the inlet channel.

5. The suction cup of claim 4, wherein one of the pressure relief valve body and a circumferential wall of the inlet channel has a ring concave, and the other of the pressure relief valve body and the circumferential wall of the inlet channel has a ring protrusion which tightly abuts against the ring concave.

6. The suction cup of claim 4, wherein the pressure relief valve body has a cone section, and the cone section is insertable within the inlet channel to annularly abut against the inlet channel and block the inlet channel.

7. The suction cup of claim 6, wherein the inlet channel has a tapered section, and the cone section is insertable within the tapered section to annularly abut against the tapered section and block the inlet channel.

8. The suction cup of claim 4, wherein the inlet channel has a neck section, the neck section has a first ring protrusive face which extends radially and inwardly, the pressure relief valve body has a second ring protrusive face which extends radially, the second ring protrusive face and the first ring protrusive face abut against each other, and the second ring protrusive face is located between the first ring protrusive face and the second air chamber.

9. The suction cup of claim 7, wherein the seat body and the cup portion define the second air chamber; the seat body has a recess, the cup portion has a protrusion which extends radially, and the inlet channel penetrates the protrusion; two opposite sides of the protrusion abut against two opposite sides of the recess of the seat body; the inlet channel includes a first flow channel and a second flow channel which is lateral to the first flow channel, and the first and second flow channels are disposed through the protrusion; one of the pressure relief valve body and a circumferential wall of the inlet channel has a ring concave, and the other of the pressure relief valve body and the circumferential wall of the inlet channel has a ring protrusion which tightly abuts against the ring concave; the ring concave and the ring protrusion respectively extend toward a direction of the pressure relief valve body moving opposite to the inlet channel; the inlet channel has a neck section, the neck section has a first ring protrusive face which extends radially and inwardly, the pressure relief valve body has a second ring protrusive face which extends radially, the second ring protrusive face and the first ring protrusive face abut against each other, and the second ring protrusive face is located between the first ring protrusive face and the second air chamber; one of the seat body and the cup portion has an annular groove, the other of the seat body and the cup portion has an engaging protrusion which is engaged within the annular groove, one of the annular groove and the engaging protrusion has at least one slot, and the other of the annular groove and the engaging protrusion has a column which is disposed within the slot; the tapered section is smaller than the cone section in extension length; the seat body has a through hole, the through hole communicates with the inlet channel, the pressure relief valve body has a body section which is disposed within the through hole and inlet channel, the body section has an annular flange, and a radial dimension of the annular flange is smaller than a caliber of the through hole and greater than a caliber of an entrance of the inlet channel; the suction cup further includes a hanging structure, the hanging structure includes a base portion which is connected to the seat body and a hanging portion, one of the base portion and the hanging portion has a penetrating hole, the other of the base portion and the hanging portion has a buckle member, the buckle member has a first clip sheet and a second clip sheet which is spacingly connected to the first clip sheet, the penetrating hole has a radially-broadened hole and a radially-narrowed hole which communicates with the radially-broadened hole, the second clip sheet has a wide section and a narrow section which is connected to the wide section, the wide section corresponds to the radially-broadened hole, the narrow section corresponds to the radially-narrowed hole, and the narrow section is longer than the wide section in a direction in which the wide section and the narrow section are arranged; the cup portion has a bottom face for contacting the surface, and the bottom face has a plurality of annular protrusive ribs.
